(19) United States
(12) Patent Application Publication
(10) Pub. No.: US 2012/0224201 A1
(43) Pub. Date: Sep. 6, 2012

(54) PRINTING DEVICE AND PRINTING METHOD THEREOF

(75) Inventor: Shigetoshi Asahina, Shizuoka (JP)

(73) Assignee: TOSHIBA TEC KABUSHIKI KAISHA, Tokyo (JP)

(21) Appl. No.: 13/407,918

(22) Filed: Feb. 29, 2012

(30) Foreign Application Priority Data
Mar. 2, 2011 (JP) 2011-45507

(51) Int. Cl. G06K 15/16

(52) U.S. Cl. 358/1.12

(57) ABSTRACT

A printing device includes a printer body, a print unit, a detecting unit, and a control unit. The printer body includes a discharge port from which the printed medium is discharged. The print unit is provided within the printer body and configured to perform a printing operation on a medium. The detecting unit is configured to detect an installation position of the printer body. The control unit is configured to selectively control a print direction of the medium discharged from the discharge port based on the installation position of the printer body detected by the detecting unit.

### CROSS-REFERENCE TO RELATED APPLICATION

This application is based upon and claims the benefit of priority from Japanese Patent Application No. 2011-045507, filed on Mar. 2, 2011, the entire contents of which are incorporated herein by reference.

### FIELD

Embodiments described herein relate generally to a printing device, e.g., for use in a point-of-sale terminal and a printing method of the printing device.

### BACKGROUND

A point-of-sale (POS) terminal can be installed on a table in a horizontal position or on a wall surface in a vertical position.

In this type of POS terminal, a medium is printed by a printer embedded therein and then issued from the POS terminal. The medium is discharged from a discharge port of a printer body.

However, the printing direction of the medium discharged from the discharge port remains the same regardless of whether the POS terminal is installed in a horizontal position or in a vertical position. Therefore, when the position of the POS terminal is changed from one of the horizontal and vertical position, the printing direction of the medium discharged from the discharge port is reversed from a view point of an operator or a customer. This poses a problem in that it becomes difficult for the customer or the operator to review the content printed on the medium while being discharged from the printer.

### BRIEF DESCRIPTION OF THE DRAWINGS

FIG. 1 is a perspective view illustrating a printer for a POS terminal according to a first embodiment of to the present disclosure, which is installed in a horizontal position.

FIG. 2 is a view illustrating the printer for the POS terminal of the first embodiment installed in a vertical position.

FIG. 3 is a block diagram illustrating the internal configuration of the printer for the POS terminal of the first embodiment.

FIG. 4 illustrates a configuration of a print unit employed in the printer for the POS terminal of the first embodiment.

FIG. 5 is a perspective view illustrating a printer for a POS terminal according to a second embodiment, which is installed in a horizontal position.

FIG. 6 is a view illustrating the printer for the POS terminal of the second embodiment installed in a vertical position.

FIG. 7 is a block diagram illustrating the internal configuration of the printer for the POS terminal of the second embodiment.

FIG. 8 is a configuration of a print unit and a switching gate employed in the printer for the POS terminal of the second embodiment.

FIG. 9 is a perspective view illustrating a printer for a POS terminal according to a third embodiment, which is installed in a vertical position.

### DETAILED DESCRIPTION

According to an embodiment of the present disclosure, a printing device includes a printer body, a print unit, a detecting unit, and a control unit. The printer body includes a discharge port from which the printed medium is discharged. The print unit is provided within the printer body and configured to perform a printing operation on a medium. The detecting unit is configured to detect an installation position of the printer body. The control unit is configured to selectively control a print direction of the medium discharged from the discharge port based on the installation position of the printer body detected by the detecting unit.

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram forms in order to facilitate describing one or more embodiments.

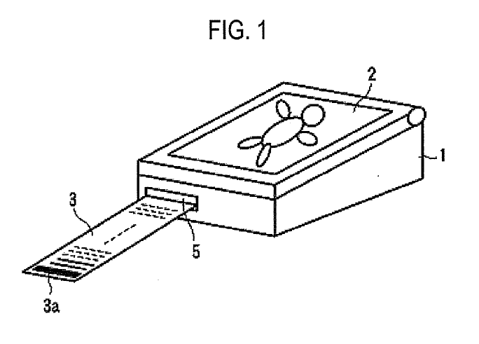

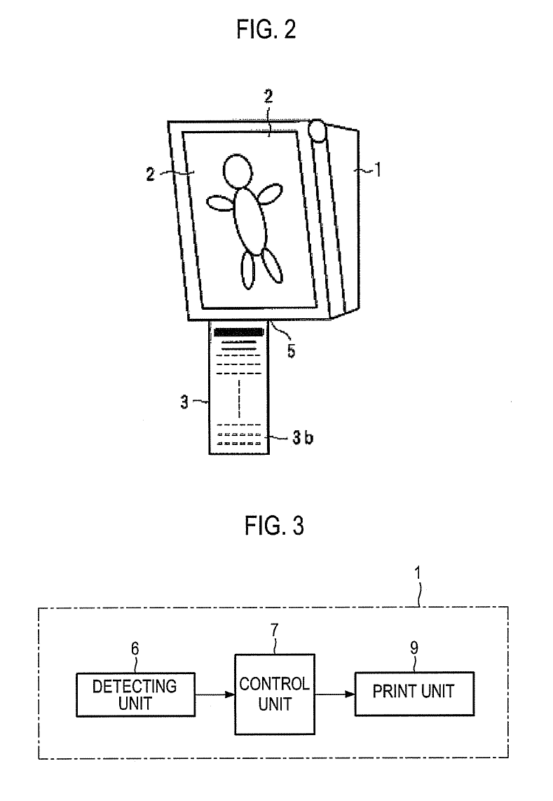

FIG. 1 is a perspective view illustrating a point-of-sale (POS) terminal according to an embodiment according to the present disclosure, which is provided with a printer. The POS terminal, when in use, is installed on a table in a horizontal position as shown in FIG. 1 or wall-hung in a vertical position as illustrated in FIG. 2.

The POS terminal includes a printer body 1 and a touch panel type display unit 2 provided on the upper surface of the printer body 1. A discharge port 5 for discharging therethrough, for example, a receipt as a printed medium, is formed on the side surface of the printer body 1.

FIG. 3 illustrates an internal configuration of the printer provided within the printer body 1. Referring to FIG. 3, a detecting unit 6 is provided within the printer body 1. A control unit 7 is connected to the detecting unit 6, and a print unit 9 is connected to the control unit 7 through a control circuit.

For example, a tilt detecting sensor, a push-down switch or a two-axis/three-axis gyro sensor is used as the detecting unit 6 to detect the installation position of the printer body 1.

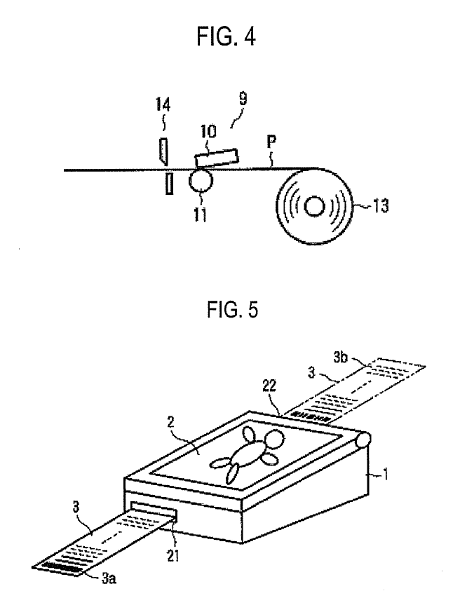

FIG. 4 illustrates a configuration of the print unit 1 according to an embodiment of the present disclosure. The print unit 9 includes a print head 10 and a platen roller 11 arranged in an opposing relationship with the print head 10. A paper P as a medium is interposed between the print head 10 and the platen roller 11. Upon rotating the platen roller 11, the paper P is drawn out and conveyed from a paper roll 13. The print head 10 prints information on the paper P in response to a control signal, which may be generated in response to an operator's touch operation on the touch panel type display unit 2.

Referring to FIG. 4, a cutter unit 14 for cutting the paper P into a specified size is provided at the downstream side of the print unit 9 along a paper conveying direction. The paper P cut by the cutter unit 14 is discharged from the discharge port 5 as a receipt 3.

The control unit 7 controls the print operation of the print unit 9 based on the installation position of the printer body 1 detected by the detecting unit 6.

More specifically, if the installation position of the printer body 1 detected by the detecting unit 6 is horizontal, the control unit 7 controls the print unit 9 so that the print head 10 can start printing on the paper P with information arranged in an order starting from a sentence head 3a, as shown in FIG. 1. If the installation position of the printer body 1 is vertical, the control unit 7 reversely controls the print unit 9 so that the print head 10 can start printing information arranged in an order starting from a sentence tail 3b, as shown in FIG. 2.

Next, description will be made on how to use the POS terminal of the first embodiment.

If the POS terminal is horizontally installed as shown in FIG. 1, the detecting unit 6 detects that the installation position of the POS terminal is horizontal. In this state, a print operation is started by touch-operating the touch panel type display unit 2. At this time, the control unit 7 causes the print head 10 to start printing on the paper P with information arranged in an order starting from the sentence head 3a. When the printing is completed, the paper P is cut into a specified size and is discharged as the receipt 3 from the discharge port 5 of the printer body 1 with the sentence head 3a being discharged first.

If the POS terminal is vertically installed as shown in FIG. 2, the detecting unit 6 detects that the installation position of the POS terminal is vertical. In this state, a print operation is started by touch-operating the touch panel type display unit 2. At this time, the control unit 7 causes the print head 10 to start printing on the paper P with information arranged in an order starting from the sentence tail 3b. When the printing is completed, the paper P is cut into a specified size and is discharged downwards as the receipt 3 from the discharge port 5 of the printer body 1 with the sentence tail 3b being discharged first.

With the first embodiment described above, the print direction of the paper P is selectively reversed depending on the installation position of the POS terminal. As such, the receipt 3 is discharged from the discharge port 5 with the sentence head 3a or the sentence tail 3b taking the lead, depending on the installation position of the POS terminal. This provides an advantage in that the operator can easily check up the printed surface of the receipt 3 regardless of the installation position of the POS terminal. Further, when the operator of the POS terminal takes out a receipt from the POS terminal and gives it to a client, the content printed on the receipt will be shown to the client in a normal head and tail order. Thus, it becomes unnecessary for the operator to reverse the direction of the receipt for the convenience of the operator.

Since the print direction is automatically reversed as the detecting unit 6 detects the installation position of the POS terminal, there is no need for the operator to manually control the print direction, e.g., by inputting an instruction on the touch panel type display unit 2. This simplifies a control system of the POS terminal.

The POS terminal may be configured to issue a receipt when in the horizontal position and to issue, e.g., a kitchen order sheet in place of the receipt when in the vertical position.

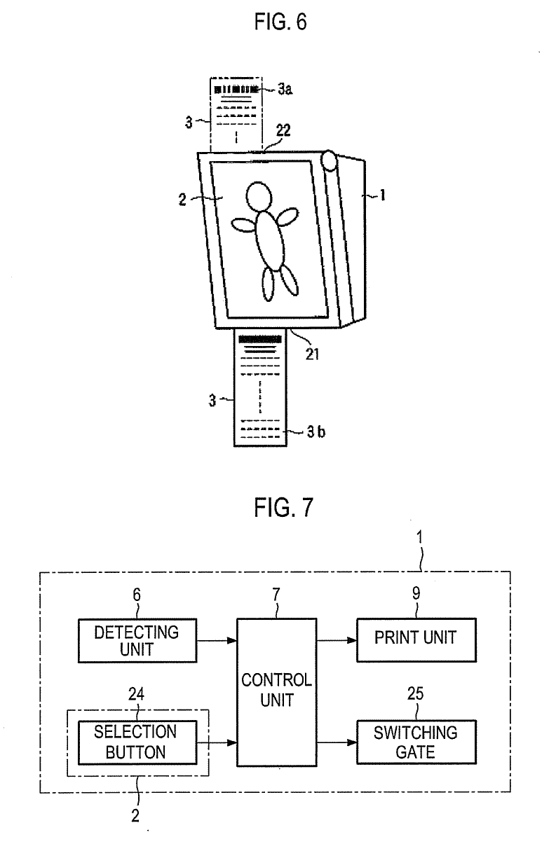

FIGS. 5 and 6 illustrate a POS terminal according to another embodiment of the present disclosure.

FIG. 5 illustrates the POS terminal installed in a horizontal position and FIG. 6 illustrates the POS terminal installed in a vertical position.

The same components as those of the first embodiment described above will be designated by like reference symbols and will not be described herein.

While only one discharge port 5 is provided in the POS terminal of the first embodiment described above, the printer body 1 of the current embodiment has a first discharge port 21 formed on one end side surface thereof and a second discharge port 22 formed on the other end side surface thereof.

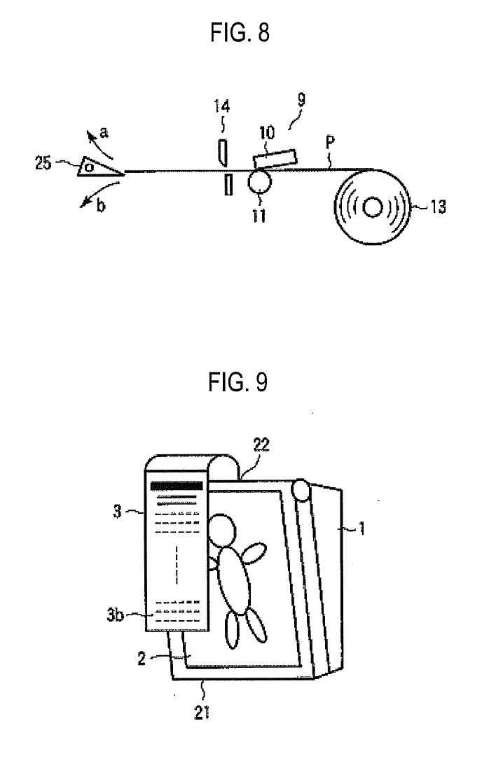

FIG. 7 is a block diagram illustrating the internal configuration of the printer provided in the printer body 1. Referring to FIG. 7, a switching gate 25 is provided in the printer body 1 and a selection button 24 for selecting one of the first and second discharge ports 21 and 22 is provided in the touch panel type display unit 2. As shown in FIG. 8, the switching gate 25 is provided at the downstream side of the print unit 9 along the medium conveying direction. Responsive to the operation of the selection button 24, the switching gate 25 switches the conveying direction of the medium to one of the directions indicated by arrows a and b, thereby selectively guiding the receipt 3 toward the first discharge port 21 or the second discharge port 22.

Next, description will be made on how to use the POS terminal of the second embodiment.

If the POS terminal is horizontally installed as shown in FIG. 5, the detecting unit 6 detects that the installation position of the POS terminal is horizontal. To start a print operation, the touch panel type display unit 2 is touch-operated and the selection button 24 is touch-operated to select, e.g., the first discharge port 21 as a discharge port for discharging the medium. Pursuant to the detection result of the detecting unit 6, the control unit 7 causes the print head 10 to start printing on the paper P with information arranged in an order starting from the sentence head 3a. When the printing is completed, the paper P is cut into a specified size and is discharged as a receipt 3 from the first discharge port 21 of the printer body 1 with the sentence head 3a being discharged first.

When the second discharge port 22 is selected by the selection button 24, the control unit 7 causes the print head 10 to start printing on the paper P with information arranged in an order starting from the sentence tail 3b. When the printing is completed, the paper P is cut into a specified size and is discharged as a receipt 3 from the second discharge port 22 of the printer body 1 with the sentence tail 3b being discharged first.

On the other hand, if the POS terminal is vertically installed as shown in FIG. 6, the detecting unit 6 detects that the installation position of the POS terminal is vertical. To start a print operation, the touch panel type display unit 2 is touch-operated and the selection button 24 is touch-operated to select, e.g., the first discharge port 21 as a discharge port for discharging the medium. Pursuant to the detection result of the detecting unit 6, the control unit 7 causes the print head 10 to start printing on the paper P with information arranged in an order starting from the sentence tail 3b. When the printing is completed, the paper P is cut into a specified size and is discharged downwards as a receipt 3 from the first discharge port 21 of the printer body 1 with the sentence tail 3b being discharged first.

When the second discharge port 22 is selected by the selection button 24, the control unit 7 causes the print head 10 to start printing on the paper P with information arranged in an order starting from the sentence head 3a. When the printing is completed, the paper P is cut into a specified size and is discharged upwards as a receipt 3 from the second discharge port 22 of the printer body 1 with the sentence head 3a being discharged first.

With the second embodiment described above, the receipt 3 can be discharged from one of the first and second discharge ports 21 and 22 as selected. Accordingly, the receipt 3 can be taken out in one of the above two directions as desired by the operator. This facilitates handling of the receipt 3.

The print direction of the paper P discharged from the first discharge port 21 or the second discharge port 22 is selectively reversed pursuant to the selection of the first discharge port 21 (or the second discharge port 22). Therefore, the operator can easily check up the printed surface of the receipt 3 regardless of whether the receipt 3 is taken out from the first discharge port 21 or the second discharge port 22.

If the receipt 3 is issued from the second discharge port 22 with the sentence tail 3b being discharged first as indicated by a dashed line in FIG. 5, it becomes easy to deliver the receipt 3 to a customer, thereby offering convenience for the customer.

FIG. 9 illustrates a POS terminal according to a third embodiment of the present disclosure.

The same components as those of the second embodiment described above will be designated by like reference symbols and will not be described herein.

In the third embodiment, the print unit can perform double-sided printing. If the POS terminal is vertically installed as shown in FIG. 9 and if the second discharge port 22 is selected as a discharge port, the rear surface of the paper P is printed with information arranged in an order starting from the sentence tail 3b. When this printing operation is completed, the paper P is discharged as a receipt 3 from the second discharge port 22 of the printer body 1 with the sentence tail 3b being discharged first. The surface of the receipt 3 thus discharged is inverted due to its weight, so that the printed surface can be exposed to the outside. Then, the receipt 3 is suspended on the front side of the touch panel type display unit 2, as shown in FIG. 9.

With the third embodiment, there is provided an advantage in that the printed content can be checked up with ease even if the receipt 3 discharged from the second discharge port 22 of the printer body 1 is suspended.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus or can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) in the apparatus.

While certain embodiments have been described, these embodiments have been presented by way of example only, and are not intended to limit the scope of the inventions. Indeed, the novel printers described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printing device comprising:
a printer body;
a print unit provided within the printer body, and configured to perform a printing operation on a printing medium, the printer body having a discharge port from which the printing medium is discharged;
a detecting unit configured to detect an installation position of the printer body; and
a control unit configured to selectively control a print direction of the printing medium discharged from the discharge port based on the installation position of the printer body detected by the detecting unit.

2. The device of claim 1, wherein the installation position is one of a horizontal position and a vertical position.

3. The device of claim 2, wherein
if the detecting unit detects that the printer body is installed in the vertical position, the control unit controls the print direction of the medium, such that the printing medium is discharged with a sentence head thereof being discharged first; and
if the detecting unit detects that the printer body is installed in the horizontal position, the control unit controls the print direction of the medium, such that the printing medium is discharged with a sentence tail thereof being discharged first.

4. A printing device comprising:
a printer body;
a print unit provided within the printer body, and configured to perform a printing operation on a medium, the printer body having first and second discharge ports from which the printed medium is discharged, the first and second discharge ports being formed on opposite surfaces of the printer body;
a detecting unit configured to detect an installation position of the printer body;
a selection unit configured to select one of the first and second discharge ports based on the detected installation position of the printer body; and
a control unit configured to selectively control a print direction of the medium depending on the installation position of the printer body detected by the detecting unit and the selection of the first and second discharge ports made by the selection unit.

5. The device of claim 4, wherein the installation position is one of a horizontal position and a vertical position.

6. The device of claim 5, wherein
if the selection unit selects the first discharge port and the detecting unit detects that the printer body is installed in the horizontal position, the printing unit performs the printing operation on the medium such that the printed medium is discharged with a sentence head thereof being discharged first; and
if the selection unit selects the second discharge port and the detecting unit detects that the printer body is installed in the horizontal position, the printing unit performs the printing operation on the medium, such that the printed medium is discharged with a sentence tail thereof being discharged first.

7. The device of claim 5, wherein
if the selection unit selects the first discharge port and the detecting unit detects that the printer body is installed in the vertical position, the printing unit performs the printing operation on the medium such that the printed medium is discharged with a sentence tail thereof being discharged first; and
if the selection unit selects the second discharge port and the detecting unit detects that the printer body is installed in the vertical position, the printing unit performs the printing operation on the medium, such that the printed medium is discharged with a sentence head thereof being discharged first.

8. The device of claim 5, wherein the print unit is further configured to perform a double-sided printing function, and
wherein if the selection unit selects the second discharge port and the detecting unit detects that the printer body is installed in the vertical position, the print unit performs the printing operation on a rear surface of the medium and discharge the medium with a sentence tail thereof being discharged.

9. A printing method performed by a printing device, the method comprising:
performing, via print unit within a printer body of the printing device, a printing operation on a medium, the printer body having a discharge port from which the printing medium is discharged;
detecting, via a detecting unit of the printing device, an installation position of the printer body; and
selectively controlling a print direction of the medium depending on the detected installation position of the printer body.

10. The method of claim 9, wherein the installation position is one of a horizontal position and a vertical position.

11. The method of claim 10, wherein
if the detecting unit detects that the printer body is installed in the vertical position, the control unit controls the print direction of the medium, such that the printing medium is discharged with a sentence head thereof being discharged first; and
if the detecting unit detects that the printer body is installed in the horizontal position, the control unit controls the print direction of the medium, such that the printing medium is discharged with a sentence tail thereof being discharged first.

12. A printing method performed by a printing device, the method comprising:
performing, via print unit within a printer body of the printing device, a printing operation on a medium, the printer body having first and second discharge ports from which the printing medium is discharged, the first and second discharge ports being formed on opposite surfaces of the printer body;
detecting, via a detecting unit of the printing device, an installation position of the printer body;
selecting, via a selection unit of the printing device, one of the first and second discharge ports based on the detected installation position of the printer body; and
selectively controlling a print direction of the medium depending on the detected installation position of the printer body and the selection made between the first and second discharge ports.

13. The method of claim 12, wherein the installation position is one of a horizontal position and a vertical position.

14. The method of claim 13, wherein
if the selection unit selects the first discharge port and the detecting unit detects that the printer body is installed in the horizontal position, the printing unit performs the printing operation on the medium such that the printed medium is discharged with a sentence head thereof being discharged first; and
if the selection unit selects the second discharge port and the detecting unit detects that the printer body is installed in the horizontal position, the printing unit performs the printing operation on the medium, such that the printed medium is discharged with a sentence tail thereof being discharged first.

15. The method of claim 13, wherein
if the selection unit selects the first discharge port and the detecting unit detects that the printer body is installed in the vertical position, the printing unit performs the printing operation on the medium such that the printed medium is discharged with a sentence tail thereof being discharged first; and
if the selection unit selects the second discharge port and the detecting unit detects that the printer body is installed in the vertical position, the printing unit performs the printing operation on the medium, such that the printed medium is discharged with a sentence head thereof being discharged first.

16. The method of claim 13, wherein if the printing operation includes a double-sided printing function, the selection unit selects the second discharge port, and the detecting unit detects that the printer body is installed in the vertical position, the print unit performs the printing operation on a rear surface of the medium and discharge the medium with a sentence tail thereof being discharged.
